(19) United States
(12) Patent Application Publication
(10) Pub. No.: US 2005/0086435 A1
(43) Pub. Date: Apr. 21, 2005

(54) Cache memory controlling apparatus, information processing apparatus and method for control of cache memory

(75) Inventor: Akinari Todoroki, Hachiqii-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/927,090

(22) Filed: Aug. 27, 2004

(30) Foreign Application Priority Data
Sep. 9, 2003 (JP) 2003-316884
Nov. 18, 2003 (JP) 2003-388021

(51) Int. Cl. G06F 12/00

(52) U.S. Cl. 711/128; 711/137; 711/138

(57) ABSTRACT

Processing in a cache memory is made appropriate. A cache memory controlling apparatus 1 detects whether data expected to be read subsequently is cached or not while data to be read is read from a processor. If the data to be read subsequently is stored in a cache, the data is stored in a pre-read cache unit 20, and if the data to be read subsequently is not stored in the cache, the data is read from an external memory and stored in the pre-read cache unit 20. Thereafter, if an address of data actually read from the processor in a subsequent cycle matches an address of data stored in the pre-read cache unit 20, the data is outputted from the pre-read cache unit 20 to the processor.

### BACKGROUND OF THE INVENTION

1. Field of the Invention

The present invention relates to an apparatus controlling a cache memory provided for efficiently transferring data between a processor and a memory device, an information processing apparatus comprising the cache memory, and a method for control of the cache memory.

2. Description of the Related Art

Cache memories have been used for enhancing the speed of processing for reading data on a memory device such as a main memory by a processor.

The cache memory is comprised of memory elements enabling data to be read at a high speed by the processor. The cache memory stores part of data stored in the memory device (hereinafter referred to as “memory device data” as appropriate), and when the processor reads data from the memory device, the data is read from the cache memory if the data is stored in the cache memory, whereby data can be read at a high speed.

There are various modes for the cache memory, but a set associative mode is commonly used.

The set associative mode is such that the cache memory is divided into a plurality of areas (ways), and data of a different address on the memory device is stored in each way, whereby the hit rate can be improved.

FIG. 19 is a schematic diagram showing the configuration of a conventional cache memory 100 of the set associative mode.

In FIG. 19, the cache memory 100 comprises a tag table 110, a data memory 120, a hit detecting unit 130 and a multiplexer (MUX) 140. Furthermore, in the cache memory 100, N elements can be stored in its storage area, and these elements are each called an “entry”. Furthermore, the cache memory 100 is of the set associative mode of 2 ways, and 2 memory device data (data of way A and way B) are stored in each entry.

The tag table 110 stores address information indicating addresses on the memory device in which memory device data of ways A and B are stored, respectively. The address information stored in the tag table 110 is referenced by the hit detecting unit 130 described later, and is used for determining whether the cache has been hit or not.

The data memory 120 stores predetermined memory device data such as data of high access frequency. Furthermore, memory device data corresponding to ways A and B, respectively, can be stored in the data memory 120.

The hit detecting unit 130 detects whether or not memory device data stored in the cache memory 100 has been hit for a read instruction from the processor. Specifically, each address information stored in the tag table 110 is referenced, and if address information corresponding to an address indicated in the read instruction from the processor is detected, it is determined that the cache has been hit. The hit detecting unit 130 outputs information indicating a hit way to the MUX 140.

The MUX 140 selects any memory device data outputted from the data memory 120, based on information indicating the way inputted from the hit detecting unit 130, and determines the memory device data to be output data to the processor (data read by the processor).

In this set associative mode, if an entry address (address for selecting any entry stored in the cache memory) is inputted from the processor, the tag table 110 and the data memory 120 are accessed for each of ways of the cache memory 100 to detect whether data has hit or not.

Accordingly, there arises a problem such that the number of accesses to unnecessary parts in the cache memory 100 increases, resulting in an increase in power consumption or a reduction in processing efficiency.

For solving problems in conventional cache memories including the cache memory 100 described above, various propositions have been made.

Japanese Patent Laid-Open No. 11-39216 (Patent document 1) discloses a method in which in the cache memory of the set associative mode having a plurality of ways, the memory device is interleaved to make an access for reducing a delay until the output of the data memory is established.

For a similar purpose, Japanese Patent Laid-Open No. 2002-328839 (Patent document 2) discloses a method in which predictions are made on ways by an associative memory. Moreover, Japanese Patent Laid-Open No. 2000-112820 (Patent document 3) and Japanese Patent Laid-Open No. 2000-347934 (Patent document 4) disclose a technique, as a technique for making predictions on the hit of the cache in advance, in which subsequent instructions are predicted taking advantage of a tendency in which instructions are often read from continuous addresses if the processor reads instructions.

In the cache memory described above, data stored in the cache memory should be written onto the memory device for ensuring coherency (consistency) with data stored in the memory device. At this time, data in the cache memory is generally written onto the memory device in a write through mode or write back mode.

In the write through mode, when the processor writes data in the cache memory, a flag indicating effectiveness for the data written in the cache memory is stored, and the same data is written on to the memory device. Consequently, consistency between data in the cache memory and data on the memory device is always maintained.

Furthermore, in the write back mode, when the processor writes data in the cache memory, the data is written onto the memory device with timing in which the data is deleted from the cache memory based on the LRU (Least Recently Used) algorithm or the like. Consequently, the number of writes of data in the cache memory onto the memory device is reduced.

Generally, access to data on the memory device has certain locality, and therefore writing onto the memory device in the write back mode is more efficient under a situation of high probability that data hits the cache memory. In particular, if it is apparent that data to be processed exists in a local address on the memory as in image processing, employment of the write back mode is highly advantageous.

If a DMAC (Direct Memory Access Controller) is used, or the memory is shared by a plurality of processors, especially high coherency should be ensured. That is, in the write back mode described above, data in the cache memory is not always consistent with data on the memory device, and therefore processing (cache flush) for writing data in the cache memory onto the memory device should be carried out before execution of DMA (Direct Memory Access).

In the processor comprising a conventional cache memory, a command for carrying out cache flush (cache flush command) is prepared, and a command for writing all data in the cache memory onto the memory device or a command for writing data of a specific entry in the cache memory onto the memory device is executed as the cache flush command.

Furthermore, processing for writing data from the cache memory onto the memory device (cache flush) is described in Japanese Patent Laid-Open No. 10-320274 (Patent document 5), Japanese Patent Laid-Open No. 9-6680 (Patent document 6) or Japanese Patent Laid-Open No. 8-339329 (Patent document 7).

In these publications, a technique for reducing time required for the cache flush operation is disclosed.

However, the techniques described in the patent documents 1 to 4 are techniques for alleviating a delay of access to data read.

That is, in the techniques described in the patent documents 1 to 4, it is difficult to solve the problem such that the number of accesses to unnecessary parts in the cache memory increases, resulting in an increase in power consumption or a reduction in processing efficiency.

Moreover, in the conventional processor comprising a cache memory, including the techniques described in the patent documents 5 to 7, when the cache flush command is executed, processing time for execution of the command is required apart from time for original processing, resulting in a reduction in processing speed.

Furthermore, if data is written onto the memory device in a write through mode, high coherency can be ensured but as described above, a write back mode is often superior as performance of the cache memory in general.

Furthermore, in the conventional cache memory, there are cases where even data that is used with high frequency is deleted from the cache memory according to the LRU algorithm or the like, or deleted indiscriminately together with other data by cache flush if time that is not used temporarily exists. In this case, data that is used with high frequency mishits the cache, resulting in a further reduction in processing speed.

In this way, in the conventional cache memory, an increase in power consumption or a reduction in processing efficiency is brought about, or the processing speed is reduced, and thus it cannot be said that processing in the cache memory is sufficiently appropriate.

A problem of the present invention is to make processing in the cache memory appropriate.

Specifically, it is a first problem of the present invention to reduce power consumption and improve processing efficiency in the cache memory.

Furthermore, it is a second problem of the present invention to enhance a processing speed in the cache memory.

### SUMMARY OF THE INVENTION

For solving the above first problem, the present invention is a cache memory controlling apparatus capable of caching at least part of stored data in a cache memory including a plurality of ways (e.g. ways A and B in “DETAILED DESCRIPTION OF THE PREFERRED EMBODIMENTS”) from a memory device storing data to be read by a processor (e.g. external memory in “DETAILED DESCRIPTION OF THE PREFERRED EMBODIMENTS”), and supplying the cached data to the processor, the cache memory control apparatus comprising:
a cache determining section (e.g. access managing unit 10 and tag table 30 in FIG. 1) determining whether or not predetermined data expected to be read subsequently to data being read by the processor is cached in any of the ways of the cache memory; and
a pre-read cache section (e.g. access managing unit 10 and pre-read cache unit 20 in FIG. 1) making an access to a way in which the predetermined data is stored, of the plurality of ways, and reading and storing the predetermined data, if it is determined by the cache determining section that the predetermined data is cached in any of the ways,
wherein the pre-read cache section outputs the stored predetermined data to the processor if the predetermined data is read subsequently to the data being read.

With this configuration, data expected to be read subsequently to data being read by the processor can be previously stored in the pre-read cache section, and then outputted to the processor, and when the data is read from the cache memory, access to unnecessary ways can be prevented. That is, it is possible to solve the problem such that the number of accesses to unnecessary parts in the cache memory increases, resulting in an increase in power consumption or a reduction in processing efficiency.

Furthermore, the cache memory comprises an address storing section storing addresses of data cached for the plurality of ways, and a data storing section storing data corresponding to the addresses, the cache determining section determines whether the predetermined data is cached or not according to whether or not the address of the predetermined data is stored in any of the ways of the address storing section, and the pre-read cache section makes an access to a way corresponding to the way of the address storing section storing the address of the predetermined data, of the plurality of ways of the data storing section.

With this configuration, whether predetermined data hits the cache or not can be determined by making an access to the address storing section, thus making it possible to reduce unnecessary power consumption generated by making an access to the data storing section when whether the predetermined data hits the cache or not is determined. Furthermore, in the data storing section, an access can be made to only a way in which predetermined data is stored, thus making it possible to further reduce power consumption.

Furthermore, the predetermined data is data expected to be read just after the data being read (e.g. data of an address subsequent to the address of the data being read, etc.).

Thus, processing for determining whether data is cached or not, storing data in the pre-read cache section, and so on should be carried out only for data expected to be read subsequently to data being read, and therefore processing efficiency can be improved.

Furthermore, data to be read by the processor is constituted as a block including a plurality of words, and, with the block as a unit, whether the predetermined data is cached or not is determined, or the predetermined data is read.

With this configuration, the processor is not required to execute a read instruction for each of the plurality of words, but the entire block can be read with one read instruction, thus making it possible to reduce power consumption and improve processing efficiency.

Furthermore, the cache determining section determines whether the predetermined data is cached or not in response to an instruction by the processor to read the last word, of a plurality of words constituting the data being read.

Generally, predetermined data is more likely hit when it is expected with timing in which a more posterior word of data being read is read by the processor.

Thus, with this configuration, data read in the processor with higher probability can be pre-read as predetermined data.

Furthermore, the cache determining section determines whether the predetermined data is cached or not in response to an instruction by the processor to read a word preceding the last word, of a plurality of words constituting the data being read.

With this configuration, whether predetermined data is cached or not can be determined in earlier timing, and therefore processing (e.g. processing for reading data from the memory device, etc.) can be carried out earlier if the data is not cached, thus making it possible to prevent generation of a wait-cycle or reduce the generated wait-cycle.

Furthermore, the pre-read cache section makes an access to a way in which the predetermined data is stored, and reads the predetermined data in response to an instruction by the processor to read the last word of a plurality of words constituting the data being read if it is determined by the cache determining section that the predetermined data is cached in any of the ways.

With this configuration, even if whether predetermined data is cached or not is determined with earlier timing, predetermined data can be actually read with timing of high probability that the predetermined data is read. Thus, the probability that predetermined data stored in the pre-read cache section is not read by the processor can be reduced, thus making it possible to prevent a reduction in processing efficiency.

Furthermore, the cache memory controlling apparatus further comprises a power consumption reducing section operating ways not involved in read of data at low power consumption, of a plurality of ways in the cache memory.

With this configuration, power consumption in unnecessary parts can be reduced, thus making it possible to further reduce power consumption of the cache memory controlling apparatus.

Furthermore, the power consumption reducing section comprises a clock gating function performing control to supply no clock signal to ways not involved in read of data.

With this configuration, unnecessary power consumption generated due to supply of the clock signal to unnecessary parts can be reduced.

Furthermore, the cache memory is a cache memory of a set associative mode.

With this configuration, in the cache memory of the set associative mode, power consumption generated due to unnecessary access to the address storing section (tag table) and the data storing section (data memory) of each way included in the entry can be considerably reduced, and processing efficiency can be improved.

Furthermore, the pre-read cache section makes an access to the memory device, and reads and stores the predetermined data if it is determined by the cache determining section that the predetermined data is not cached in any of the ways of the cache memory.

With this configuration, if predetermined data is not cached, processing for reading the predetermined data from the memory device can be carried out earlier, thus making it possible to prevent generation of a wait-cycle or reduce the generated wait-cycle.

Furthermore, the present invention is a method for control of a cache memory for caching at least part of stored data in a cache memory including a plurality of ways from a memory device storing data to be read by a processor, and supplying the cached data to the processor, the method comprising:
a cache determining step of determining whether or not predetermined data expected to be read subsequently to data being read by the processor is cached in any of the ways of the cache memory;
a pre-read cache step of making an access to a way in which the predetermined data is stored, of the plurality of ways, and reading and storing the predetermined data, if it is determined in the cache determining step that the predetermined data is cached in any of the ways; and
an output step of outputting to the processor the predetermined data stored in the pre-read cache step if the predetermined data is read subsequently to the data being read, by the processor.

In this way, according to the present invention, power consumption in the cache memory can be reduced and processing efficiency can be improved.

Furthermore, for solving the above second problem, the present invention is an information processing apparatus comprising a cache memory capable of caching at least part of stored data from a memory device storing data to be read, and capable of being accessed in a plurality of access modes including at least any one of a write back mode and a write through mode, wherein an access can be made to the cache memory with the switching done between the plurality of access modes during execution of a program.

Furthermore, an access can be made to the cache memory with the switching done between the write back mode and write through mode during execution of a program.

Furthermore, the access modes includes a write flush mode in which when data is written, data is not written in an area where the data is stored so that the area is released in the cache memory, and the data is written in a predetermined address in the memory device.

Furthermore, in the write flush mode, when data is written, the data is written in a predetermined address in the memory device without making an access to the cache memory if the data is not stored, in the cache memory.

Furthermore, an access can be made to the cache memory with the switching done between the write back mode and write flush mode during execution of a program.

Furthermore, after coherency between data stored in the cache memory and data stored in the memory device is ensured, the switching can be done to the write through mode or write flush mode.

Furthermore, the access modes include a lockmode in which when data is read or written, the data stored in the cache memory is held in distinction from other data.

The cache memory is a cache memory of the set associative mode including a plurality of ways, and the lock mode can be set focusing on a specific way in the plurality of ways.

Furthermore, an access can be made to the cache memory with the switching done between the write back mode and lock mode during execution of a program.

Furthermore, the plurality of access modes are associated with some of addresses in a memory space for which a read or write instruction is provided, and the access mode in each instruction can be set by designating an address corresponding to the access mode.

Furthermore, the present invention is a method for control of a cache memory in an information processing apparatus comprising a cache memory capable of caching at least part of stored data from a memory device storing data to be read, and capable of being accessed in a plurality of access modes including at least any one of a write back mode and a write through mode, wherein an access is made to the cache memory with the switching done between the plurality of access modes during execution of a program.

According to the present invention, an instruction to read or write data can be executed in the write flush mode in addition to the conventional write back mode and write through mode.

Thus, high coherency between data in the cache memory and data in the memory device can be ensured without performing cache flush, thus making it possible to enhance the processing speed of the information processing apparatus.

Furthermore, when the instruction to write data is executed in the write flush mode, an area of the cache memory in which written data is stored is released, thus making it possible to use the cache memory more efficiently.

Furthermore, according to the present invention, since the read or write instruction in the lock mode can be executed, data that is used with high frequency and kept at a fixed value, or the like, can be held in the cache memory as required, the hit rate of the cache is improved, and the processing speed can be enhanced.

Furthermore, according to the present invention, the switching can be done among the write back mode, the write flush mode, the lock mode and the write flush mode during execution of a program.

Thus, the mode of the instruction can be flexibly changed according to the contents of processing of a program, and thus processing efficiency can be improved.

In this way, according to the above invention, processing in the cache memory can be made appropriate.

### BRIEF DESCRIPTION OF THE DRAWINGS

FIG. 1 shows the configuration of a cache memory controlling apparatus 1 applying the present invention;

FIGS. 2A and 2B show the configurations of data stored in a tag table 30 and a data memory 40;

FIG. 3 is a state-transition diagram showing basic operations of the cache memory controlling apparatus 1;

FIG. 4 is a state-transition diagram showing operations of a state machine “sm-exmem-access” constructed on the cache memory controlling apparatus 1;

FIG. 5 is a timing chart showing an example of operation where data read by a processor continuously hits a pre-read cache;

FIG. 6 is a timing chart showing an example of operation where data read by the processor does not hit the pre-read cache;

FIG. 7 is a timing chart showing an example of operation where data read by the processor hits neither the pre-cache nor a cache;

FIG. 8 is a timing chart showing an example of operation where data read by the processor does not hit the cache although it is data of continuous addresses;

FIG. 9 is a state-transition diagram showing operations of preliminary pre-read processing;

FIG. 10 shows a configuration where the cache memory controlling apparatus 1 is provided with a clock gating function;

FIG. 11 shows the configuration of a power consumption controlling unit 70;

FIG. 12 is a schematic diagram showing the configuration of an information processing apparatus 2 applying the present invention;

FIG. 13 is a block diagram showing the functional configuration of a cache memory 220;

FIG. 14 shows an address map of a memory space constituted by memories 240a and 240b;

FIG. 15 shows a state-transition diagram of each flag where a read instruction is provided;

FIG. 16 shows a state-transition diagram of each flag where a write instruction is provided;

FIG. 17 is a flow chart showing processing where the switching is done between a write back mode and a write flush mode during execution of a program;

FIG. 18 is a flow chart showing processing where the switching is done between a write back mode and a lock mode during execution of a program; and

FIG. 19 shows a schematic diagram showing the configuration of a conventional set associative mode cache memory 100.

### DETAILED DESCRIPTION OF THE PREFERRED EMBODIMENTS

Embodiments of the present invention will be described below with reference to the drawings.

(First Embodiment)

First, the configuration will be described.

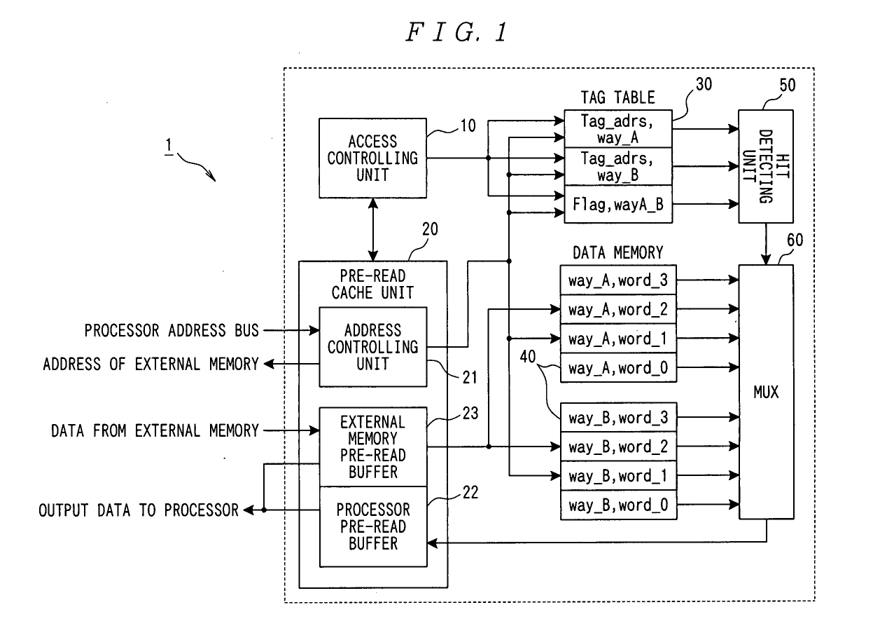

FIG. 1 shows the configuration of a cache memory controlling apparatus 1 applying the present invention.

In FIG. 1, the cache memory controlling apparatus 1 comprises an access managing unit 10, a pre-read cache unit 20, a tag table 30, a data memory 40, a hit detecting unit 50 and a MUX 60.

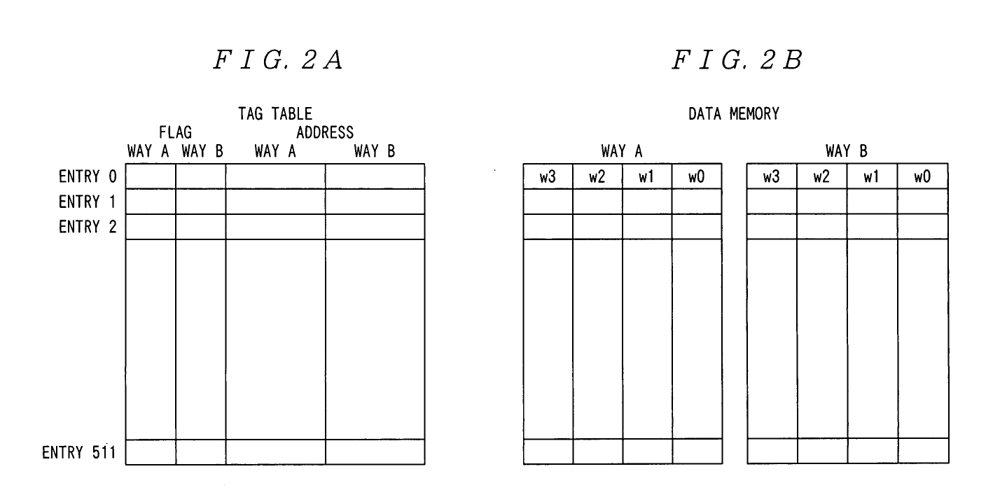

Furthermore, FIGS. 2A and 2B show the configurations of data stored in the tag table 30 and the data memory 40, wherein FIG. 2A shows the configuration of data in the tag table 30, and FIG. 2B shows the configuration of data in the data memory 40.

The configuration of the cache memory controlling apparatus 1 will be described below based on FIG. 1, with a reference made to FIGS. 2A and 2B as appropriate. Furthermore, here, it is assumed that the cache memory controlling apparatus 1 is of set associative mode of 2 ways (ways A and B).

The access managing unit 10 controls the entire cache memory controlling apparatus 1, and operates the cache memory controlling apparatus 1 in accordance with a state transition diagram.

For example, if data of an address indicated in a read instruction is stored in the pre-read cache unit 20, the access managing unit 10 outputs data corresponding to the address to a processor, and expects data to be read subsequently, and stores the expected data in a processor pre-read buffer 22 of the pre-read cache unit 20, based on a read instruction inputted from the processor.

If data of the address indicated in the read instruction is not stored in the pre-read cache unit 20, the access managing unit 10 makes a reference to the tug table 30. If the address is stored in the tag table 30, the access managing unit 10 stores data corresponding to the address in the processor pre-read buffer 22 from the data memory 40.

Furthermore, if the address indicated in the read instruction is not stored in the tag table 30, the access managing unit 10 makes an access to an external memory, and stores data of the address in an external memory pre-read buffer 23 of the pre-read cache unit 20.

The pre-read cache unit 20 receives the read instruction inputted from the processor, and outputs the address indicated in the read instruction to the access managing unit 10. Furthermore, the pre-read cache unit 20 previously reads data expected to be read by the processor from the data memory 40 or external memory and stores the data according to an instruction of the access managing unit 10, and outputs the data to the processor if it is actually read from the processor.

Specifically, the pre-read cache unit 20 comprises an address controlling unit 21, the processor pre-read buffer 22 and the external memory pre-read buffer 23.

The address controlling unit 21 obtains an address of data to be read from a read instruction inputted from the processor, and outputs the same to the access managing unit 10. Furthermore, the address controlling unit 21 outputs an address to be read to the tag table 30 and the data memory 40 when data cached in the data memory 40 is read, and outputs an address to be read to the external memory when data not cached in the data memory 40 is read from the external memory.

Furthermore, if the address controlling unit 21 is instructed to read (pre-read) data by the access managing unit 10, and the address of the data is stored in the tag table 30, the address controlling unit 21 outputs the address to only a way in which the data is stored, of ways of the data memory 40.

Accordingly, the number of accesses to unnecessary ways can be reduced, thus making it possible to reduce power consumption and improve processing efficiency.

The processor pre-read buffer 22 receives data read from the data memory 40 through the MUX 60, and stores it as data to be outputted to the processor.

The external memory pre-read buffer 23 receives data read from the external memory, and stores it as data to be outputted to the processor. Furthermore, the data stored in the external memory pre-read buffer 23 is stored in the data memory 40 in clock timing in which processing is not carried out in the cache memory controlling apparatus 1.

As shown in FIG. 2A, the tag table 30 stores a flag indicating whether data stored in the data memory 40 has hit the cache or not, and an address on the external memory in which data stored in the data memory 40 is stored for each of entries (0 to 511th entries where the number of entries N=512). Furthermore, in each entry, flags and addresses corresponding to ways A and B are stored. By making a reference to addresses stored in the tag table 30, whether data in the data memory 40 has hit the cache or not can be determined.

The data memory 40 stores predetermined memory device data for each entry. Furthermore, the data memory 40 handles 4 words as one block, and when data is read from the data memory 40, 4 words (w0 to w4) of any of ways included in the entry can be read collectively. However, some of words in one block (e.g. words w1 to w3) can also be read.

If an address indicated in the read instruction is inputted from the address controlling unit 21 to the tag table 30, the hit detecting unit 50 detects whether memory device data stored in the data memory 40 has hit or not. Specifically, a reference is made to each of addresses stored in the tag table 30, and if the address inputted from the address controlling unit 21 is detected, it is determined that the cache has been hit. The hit detecting unit 50 outputs information indicating a hit way to the MUX 60.

The MUX 60 receives the information indicating the hit way from the hit detecting unit 50, and receives memory device data from the storage area of each way of the data memory 40. The MUX 60 selects memory device data corresponding to the way inputted from the hit detecting unit 50, and outputs the data to the processor pre-read buffer 22.

Operations will now be described.

The cache memory controlling apparatus 1 makes a state transition corresponding to a predetermined operation mainly by control of the access managing unit 10.

First, basic operations of the cache memory controlling apparatus 1 will be described.

In basic operations of the cache memory controlling apparatus 1, a reference is made to the tag table 30 with timing in which the address of the last word of memory device data to be read is outputted from the processor, and whether data expected to be read subsequently (hereinafter referred to as “predetermined data”) hits the cache or not is detected (pre-read). Thus, the cache can be pre-read for data expected to be actually read with high possibility, thus making it possible to improve the hit rate of data in the pre-read cache unit 20.

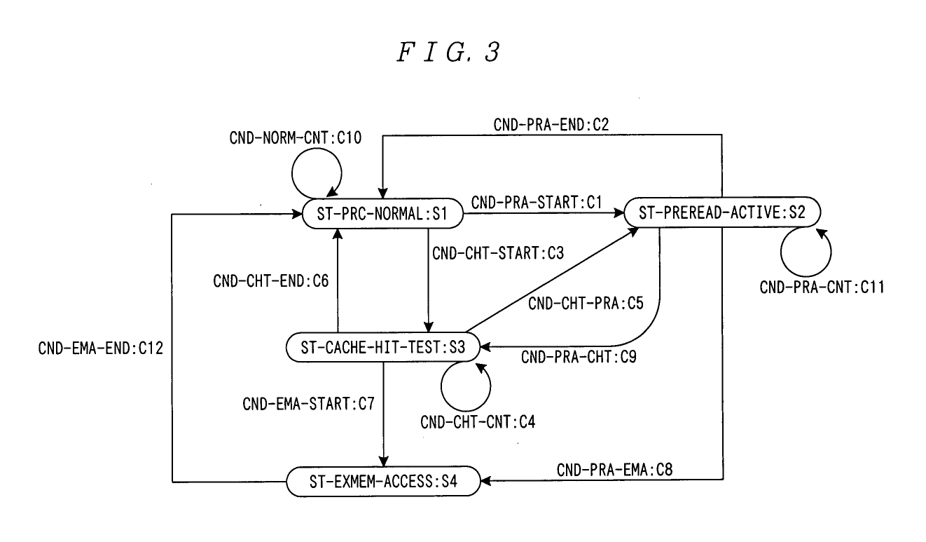

FIG. 3 is a state-transition diagram showing basic operations of the cache memory controlling apparatus 1.

In FIG. 3, the cache memory controlling apparatus 1 makes a transition among states S1 to S4, and transition conditions C1 to C12 are defined for making a transition between the states.

In the state S1 (ST-PRC-NORMAL), if predetermined data is stored in the processor pre-read buffer 22 (hits a pre-read cache), the data is outputted to the processor in a block unit.

Furthermore, in the state S1, if predetermined data is not stored in the processor pre-read buffer 22, a transition is made to a state (ST-PREREAD-ACTIVE) in which based on an address to be read, accesses are made to the tag table 30 and the data memory 40, and data matching the address is read from the data memory 40.

Further, in the state S1, read of the cache (read of the data memory 40) is not performed until read of the last word of the block of data read from the external memory is completed.

In the state S2 (ST-PREREAD-ACTIVE), an access is made to only the tag table 30 based on the address of predetermined data, and if it matches the address stored in the tag table 30 (it hits the cache), data corresponding to the address is read from the data memory 40.

In the state S3 (ST-CACHE-HIT-TEST), accesses are made to the tag table 30 and the data memory 40, and whether the address of predetermined data matches the address in the tag table 30 or not is detected. In the state S3, data corresponding to the address matching the address of the predetermined data is read from the data memory 40.

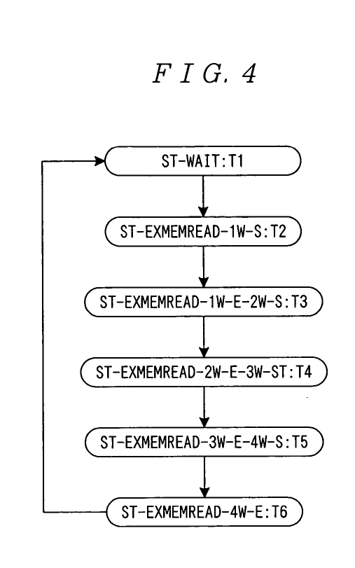

In the state S4 (ST-EXMEM-ACCESS), a state machine “sm-exmem-access” (see FIG. 4) for reading the external memory is started to read the external memory. The time of making a transition from the state S4 to other state is a time point at which read of one word is completed, and it is before completion of the operation of the state machine “sm-exmem-access”. That is, in other state, await-cycle for waiting read of the external memory may be generated.

The transition condition C1 (CND-PRA-START) means that in the state S1, the address of the last word (word of which the last digit of the address expressed by a hexadecimal number is “C”) of data to be read is inputted from the processor.

The transition condition C2 (CND-PRA-END) means that a return to the state S1 is made in a next cycle if no wait-cycle is generated in the state S2.

The transition condition C3 (CND-CHT-START) means that predetermined data does not hit the pre-read cache in the state S1 (predetermined data is stored in the processor pre-read buffer 22).

The transition condition C4 (CND-CHT-CNT) is a condition for continuing the state S3. That is, it is a condition for making accesses to the tag table 30 and the data memory 40 to continuously check a cache hit because predetermined data is not stored in the pre-read cache unit 20. Furthermore, if for a branch instruction, a branch destination address is the last address of a block, and the state is the state S3, an access will be made to the first word of the block in the next cycle, and therefore if the pre-read cache is not hit continuously, it is determined that the pre-read cache is mishit.

The transition condition C5 (CND-CHT-PRA) is a condition for making a transition from the state S3 to the state S2. That is, it is a condition for making a transition from a state in which accesses are made to the tag table 30 and the data memory 40 to check a cache hit to a state in which an access is made to only the tag table 30 to check a cache hit because predetermined data is not stored in the pre-read cache unit 20. Furthermore, if for the branch instruction, a branch destination address is the last but one (word of which the last digit of the address expressed by a hexadecimal number is “8”), and the state is the state S3, an access will be made to the last data of the block in the next cycle, i.e. a transition to the state S2 will be made, and therefore a return to the state S1 is not made, but a direct transition to the state S2 is made.

The transition condition C6 (CND-CHT-END) means that a return to the state S1 is made if the pre-read cache is hit when the branch destination address is the first and second of the block (word of which the last digit of the address expressed by a hexadecimal number is “0” or “4”) in the state S3.

The transition condition C7 (CND-EMA-START) means that the cache is not hit (data to be read is not stored in the data memory 40) in the state S3.

The transition condition C8 (CND-PRA-EMA) means that the cache is not hit in the state S2.

The transition condition C9 (CND-PRA-CHT) means that the pre-read cache is not hit in the state S2.

The transition state C10 (CND-NORM-CNT) means that the pre-read cache is hit, or an access is made to the external memory in the state S1.

The transition condition C11 (CND-PRA-CNT) means that pre-read processing is continued in the state S2.

The transition condition C12 (CND-EMA-END) means that an access to the external memory is completed in the state s4.

The state machine “sm-exmem-access” for reading the external memory will now be described.

FIG. 4 is a transition-state diagram showing operations of the state machine “sm-exmem-access” constructed on the cache memory controlling apparatus 1.

In FIG. 4, the cache memory controlling apparatus 1 makes a transition among states T1 to T6.

In the state T1 (ST-WAIT), access to the external memory is stopped. In the state T1, a transition to the state T2 is made in predetermined timing.

In the state T2 (ST-EXMEM-READ-1W-S), the first word of data to be read is read from the external memory, and when processing for reading the data is completed, a transition to the state T3 is made.

In the state T3 (ST-EXMEM-READ-1W-E-2W-S), the second word of data to be read is read from the external memory, and when processing for reading the data is completed, a transition to the state T4 is made.

In the sate T4 (ST-EXMEM-READ-2W-E-3W-S), the third word of data to be read is read from the external memory, and when processing for reading the data is completed, a transition to the state T5 is made.

In the state T5 (ST-EXMEM-READ-3W-E-4W-S), the fourth word of data to be read is read from the external memory, and when processing for reading the data is completed, a transition to the state T6 is made.

In the state T6 (ST-EXMEM-READ-4W-E), a return to the state T1 is made in response to completion of processing for reading the fourth word of data to be read from the external memory.

As a result of making a transition between the states, as shown in FIGS. 3 and 4, the cache memory controlling apparatus 1 specifically carries out the following operations according to data to be read by the processor.

First, an example where data read by the processor continuously hits the pre-read cache will be described.

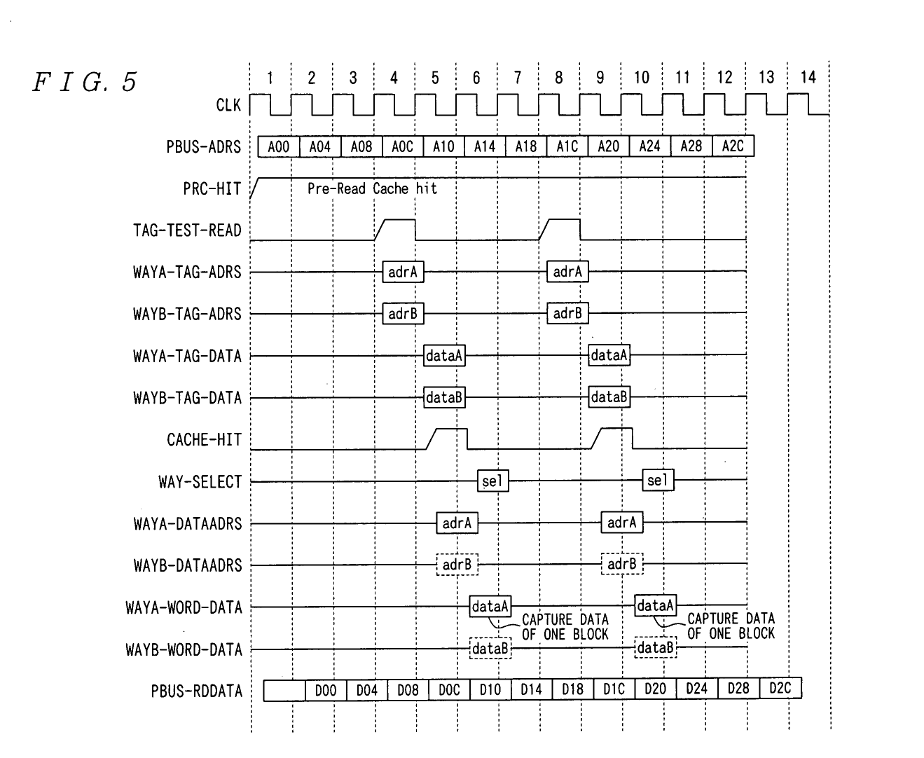

FIG. 5 is a timing chart showing an example of operation where data read by the processor continuously hits the pre-read cache.

In FIG. 5, the case is shown where data of continuous addresses (data of addresses “A00 to A0C”, “A1 to A1C” and “A20 to A2C”) are read by the processor. Furthermore, data represented by addresses “A00 to A0C”, “A1D to A1C” and “A20 to A2C” are hereinafter referred to as first to third data, respectively.

In FIG. 5, the address of second data being predetermined data is inputted to each way of the tag table 30 with timing (in cycle “4”) in which the address of the last word (address “A0C”) in first data is inputted from the processor (cycle “4”).

In next clock timing (cycle “5”), the address stored in each way of the tag table 30 is outputted, and whether the address matches the address of second data or not is determined, and the former matches the latter in this case, and therefore it is detected that the cache has been hit (CACHE-HIT=1). Furthermore, at this time, the address of second data is inputted to a way in which second data is stored of the data memory 40 (here, way A shown with a solid line in FIG. 5, and way B in which second data is not stored is shown with a dotted line. The same is applied hereinbelow) (WAYA-DATA-ADRS, WAYB-DATA-ADRS).

In subsequent clock timing (cycle “6”), data of the way in which second data is stored (WAYA-TAG-DATA, WAYB-TAG-DATA) is outputted from the data memory 40, and information for selecting any way (WAY-SELECT) is outputted from the hit detecting unit 50. As a result, memory device data of the selected way (data “D10”) is outputted to the processor (PBUS-RDDATA).

That is, for a read instruction from the processor, provided in the cycle “5”, the cache memory controlling apparatus 1 outputs corresponding memory device data in the cycle “6”.

Furthermore, in the cache memory controlling apparatus 1, memory device data can be read in a block unit and therefore by reading data “D10”, other data of the same block (data “D14” to “D1C”) are read collectively, and stored in the processor pre-read buffer 22. As a result, 3 words subsequent to data “D10” are outputted from the processor pre-read buffer 22 to the processor subsequently to data “D10” without making accesses to the tag table 30 and the data memory 40″ for reading each word.

Furthermore, the cache memory controlling apparatus 1 pre-reads third data by the processing described above, and similarly outputs the same to the processor while outputting second data to the processor.

An example where data read by the processor does not hit the pre-read cache will now be described.

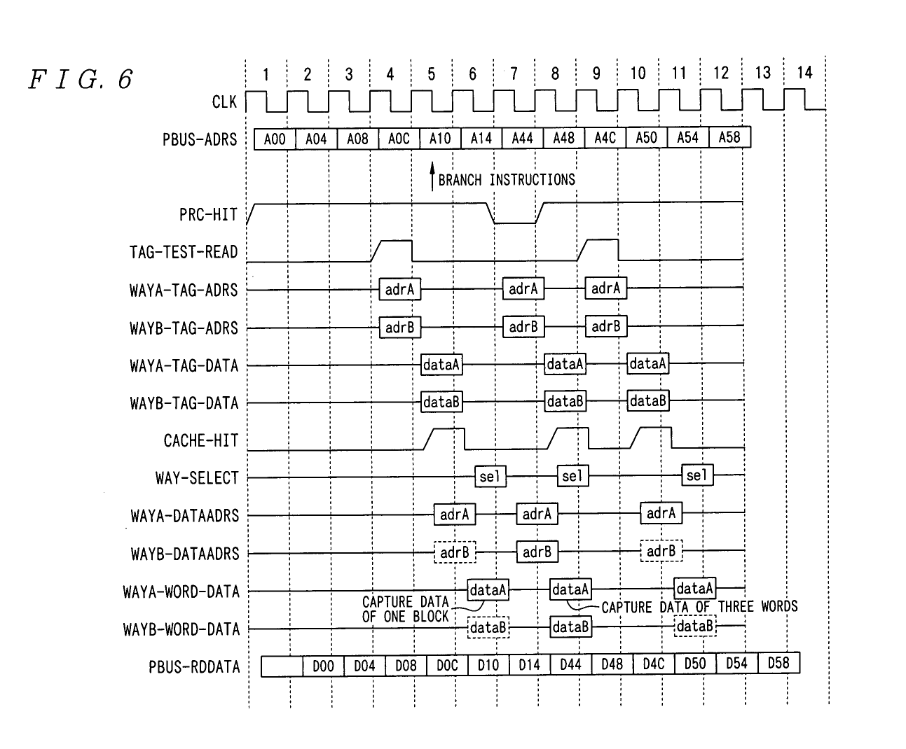

FIG. 6 is a timing chart showing an example of operation where data read by the processor does not hit the pre-read cache. Data names, signal names and the like in FIG. 6 are same as those in FIG. 5.

In FIG. 6, operations until the cycle “6” are almost same as operations until the cycle “6” shown in FIG. 5. However, the first word of second data read in the cycle “5” is a branch instruction, and the instruction is executed in the cycle “6”.

In the cycle “7”, it is detected that data of an address “A44” being a branch destination does not hit the pre-read cache (PRC-HIT=0) because it is not stored in the processor pre-read buffer 22. At this time, the cache memory controlling apparatus 1 outputs the address of a block including the word of the address “A44” (hereinafter referred to as “branch destination data”) to each way of the tag table 30 and the data memory 40 to output memory device data “D44” corresponding to the address “A44” in the next cycle for supplying data in no wait.

In the cycle “8”, the address stored in each way (WAYA-TAG-DATA, WAYB-TAG-DATA) is outputted from the tag table 30, and data of each way (WAYA-TAG-DATA, WAYB-TAG-DATA) is outputted from the data memory 40. At this time, the address stored in each way of the tag table 30 matches the address of the branch destination data, and therefore it is detected that the cache is hit (CACHE-HIT=1). Further, information for selecting any way (WAY-SELECT) is outputted from the hit detecting unit 50. As a result, memory device data of the selected way (data “D44”) is outputted to the processor (PBUS-RDDATA).

That is, for the instruction to read a branch destination from the processor, provided in the cycle “7”, the cache memory controlling apparatus 1 outputs corresponding memory device data in the cycle “8”.

Here, the address “A44” being a branch destination is the second word of the block and therefore in the cache memory controlling apparatus 1, second to fourth words of the block (words of addresses “A44” to “A4C) are read collectively, and stored in the processor pre-read buffer 22.

Thereafter, the cache memory controlling apparatus 1 pre-reads subsequent data and outputs the same to the processor while outputting branch data to the processor as in the case of processing in FIG. 5.

An example where data read by the processor hits neither the pre-read cache nor the cache will now be described.

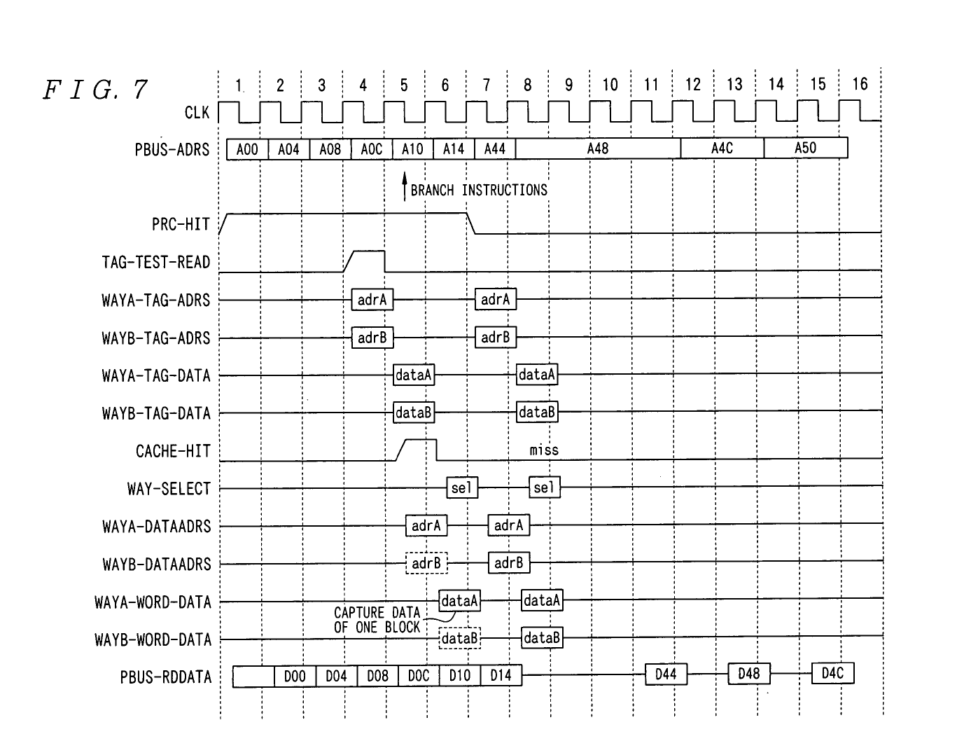

FIG. 7 is a timing chart of an example of operation where data read by the processor hits neither the pre-read cache nor the cache. Data names, signal names and the like in FIG. 7 are same as those in FIG. 5.

In FIG. 7, operations until the cycle “7” are same as operations until the cycle “7” shown in FIG. 6.

In the cycle “8”, the address stored in each way (WAYA-TAG-DATA, WAYB-TAG-DATA) is outputted from the tag table 30, and data of each way (WAYA-TAG-DATA, WAYB-TAG-DATA) is outputted from the data memory 40. At this time, the address stored in each way of the tag table 30 does not match the address of branch destination data, and therefore it is detected that the cache is not hit (CACHE-HIT=0).

Because data of the address “A44” can not be read, the cache memory controlling apparatus 1 reads data from the external memory. Thus, wait cycles, equivalent to 3 cycles until data can be captured from the external memory, are generated.

The cache memory controlling apparatus 1 sequentially stores the branch destination data captured from the external memory in the external memory pre-read buffer 23. At this time, for acquiring data from the external memory, 2 cycles are required for one word (data “D44 to D48”) unlike the case of the cache. After storing the branch destination data in the external memory pre-read buffer 23, the cache memory controlling apparatus 1 pre-reads subsequent data and similarly outputs the same to the processor as in the case of processing in FIG. 5. Furthermore, the branch destination data stored in the external memory pre-read buffer 23 is cached in the data memory 40 with timing in which no access is made to the data memory 40. Further, if in a state in which data captured from the external memory is stored in the external memory pre-reading buffer 23, an instruction to read the data is inputted from the processor, data stored in the external memory pre-reading buffer 23 is outputted to the processor.

An example where data read by the processor cannot be pre-read (does not hit the cache) although it is data of continuous addresses will now be described. In this case, predetermined data should be captured from the external memory.

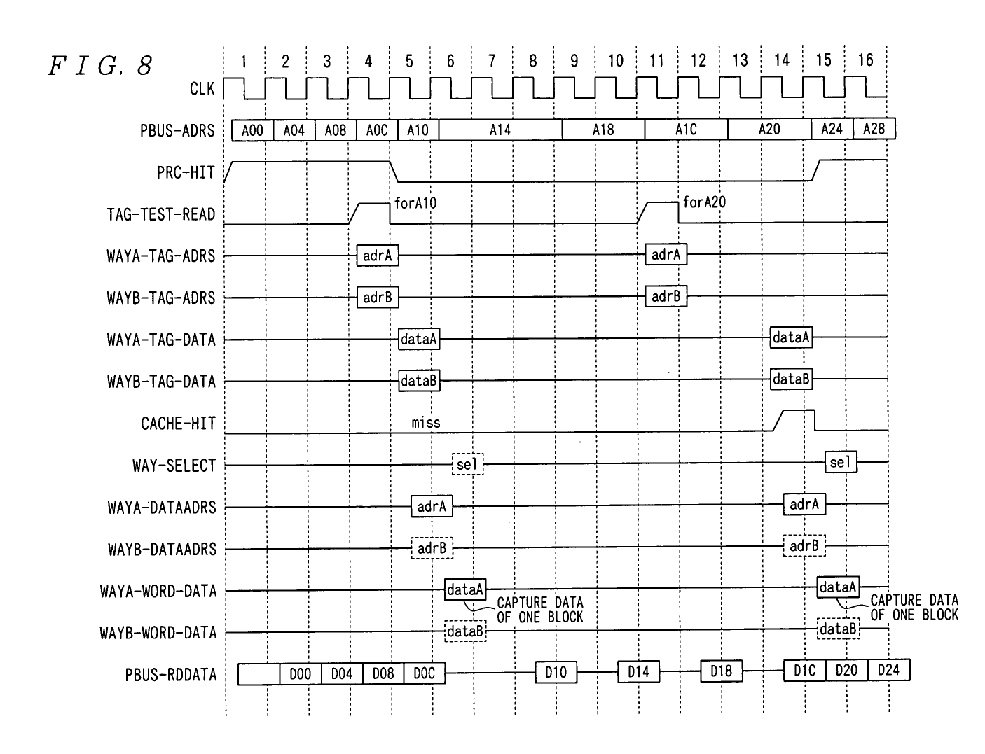

FIG. 8 is a timing chart showing an example of operation where data read by the processor does not hit the cache although it is data of continuous addresses. Data names and signal names in FIG. 8 are same as those in FIG. 5.

In FIG. 8, operations in cycles “4 and 5” are almost same as operations in cycles “6 and 7” shown in FIG. 7. However, in the case of FIG. 8, access to the external memory is immediately started in the cycle “5” in which it is detected that the cache is not hit.

Words of predetermined data are sequentially captured from the external memory 3 cycles after an access is made to the external memory (in cycle “8”).

That is, data in the external memory is outputted to the processor after 3 cycles with respect to the cycle “5” in which the address of data to be read (address “A10”) is inputted from the processor.

As a result, data in the external memory can be captured one cycle earlier than the case where the address of data to be read is inputted from the processor, and then whether the data hits the cache or not is detected as in the conventional method. That is, in the conventional method, 4 cycles are required after a read instruction is inputted from the processor until data is outputted to the processor, but the number of cycles is reduced to 3 cycles in FIG. 8.

In explanation with FIGS. 3 to 8, whether predetermined data hits the cache or not is detected (pre-read) with timing in which the address of the last word of memory device data to be read is outputted from the processor, pre-read may be performed with timing in which the address of the first word of memory device data to be read is inputted from the processor. In this case, the probability that pre-read data is actually read from the processor decreases, but a penalty of the wait-cycle can be alleviated if the cache is not hit.

Operations where pre-read is performed with timing in which the address of the first word of memory device data to be read is inputted from the processor (hereinafter referred to as “preliminary pre-read processing”) will be described below.

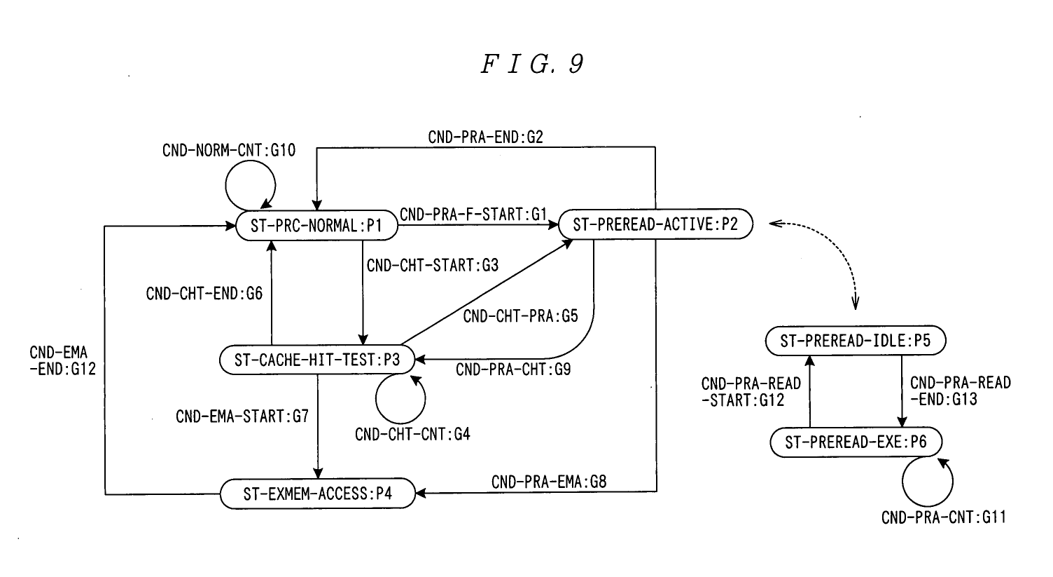

FIG. 9 is a state-transition diagram showing operations of preliminary pre-read processing.

In FIG. 9, the cache memory controlling apparatus 1 makes a transition among states P1 to P4 and state P5 and P6, and transition conditions G1 to G14 for making a transition between the states are defined.

States P1 to P4 and transition conditions G2 to G12 in FIG. 9 are same as states S1 to S4 and transition conditions C2 to C12 in FIG. 3, respectively, and therefore descriptions thereof are omitted, and only different parts are described.

The state P5 (ST-PREREAD-IDLE) is an idle state for delaying timing.

That is, idle states in constant cycles are inserted for eliminating a “deviation” such that the timing of capture of data to be read in the processor pre-read buffer 22 is too early if pre-read is performed with timing in which the address of the first word of the block is inputted from the processor.

In the state P6 (ST-PREREAD-EXE), data is transferred from the data memory 40 to the processor pre-read buffer 22.

The transition condition G1 (CND-PRA-F-START) means that the address of the first word of data to be read (word of which the last digit of the address expressed by a hexadecimal number is “0”) is inputted from the processor in the state P1.

The transition condition G13 (CND-PRA-READ-START) means that the address of the last word of data to be read (word of which the last digit of the address expressed by a hexadecimal number is “C”) is inputted from the processor in the state P5.

The transition condition G14 (CND-PRA-READ-END) means that transfer of data from the data memory 40 to the processor pre-read buffer 22 is completed.

As shown in FIG. 9, as a result of making a transition between the states, the cache memory controlling apparatus 1 carries out operations corresponding to FIGS. 5 to 8 described above, for example. Here, specific operations are omitted.

As described above, the cache memory controlling apparatus 1 according to this embodiment detects whether data expected to be read subsequently is cached or not (whether the data is stored in the data memory 40 or not) when data to be read is read from the processor. If data expected to be read subsequently is stored in the cache, the data is stored in the pre-read cache unit 20, and if data expected to be read subsequently is not stored in the cache, the data is read from the external memory and stored in the pre-read cache unit 20. Thereafter, if the address of data actually read from the processor in the subsequent cycle matches the address of data stored in the pre-read cache unit 20, the data is outputted from the pre-read cache unit 20 to the processor. If the address of data actually read from the processor in the subsequent cycle does not match the address of data stored in the pre-read cache unit 20, an access is made to the external memory at this time.

Accordingly, when the address of data to be read is inputted from the processor, it is not necessary to always make accesses to ways of the tag table 30 and the data memory 40, but accesses should be made thereto only if data to be read is stored in the data memory 40.

Therefore, access to unnecessary parts in the cache memory controlling apparatus 1 can be prevented, thus making it possible to reduce power consumption and improve processing efficiency.

Furthermore, the cache memory controlling apparatus 1 pre-reads predetermined data with timing in which the address of the last word of data to be read is inputted.

Thus, data expected to be read in the subsequent cycle with high probability can be stored in the pre-read cache unit 20, and therefore the number of accesses to unnecessary data can be reduced, thus making it possible to reduce power consumption.

The cache memory controlling apparatus 1 can pre-read predetermined data earlier than the timing in which the address of the last word is inputted, e.g. with timing in which the address of the first word of data to be read is inputted.

In this case, the hit of the cache is detectedwith earlier timing, and therefore if the cache is not hit, processing for reading data to be read from the external memory can be carried out earlier, thus making it possible to prevent generation of wait-cycles or reduce the number of wait-cycles.

Power consumption can be further reduced by providing a clock gating function in the cache memory controlling apparatus 1.

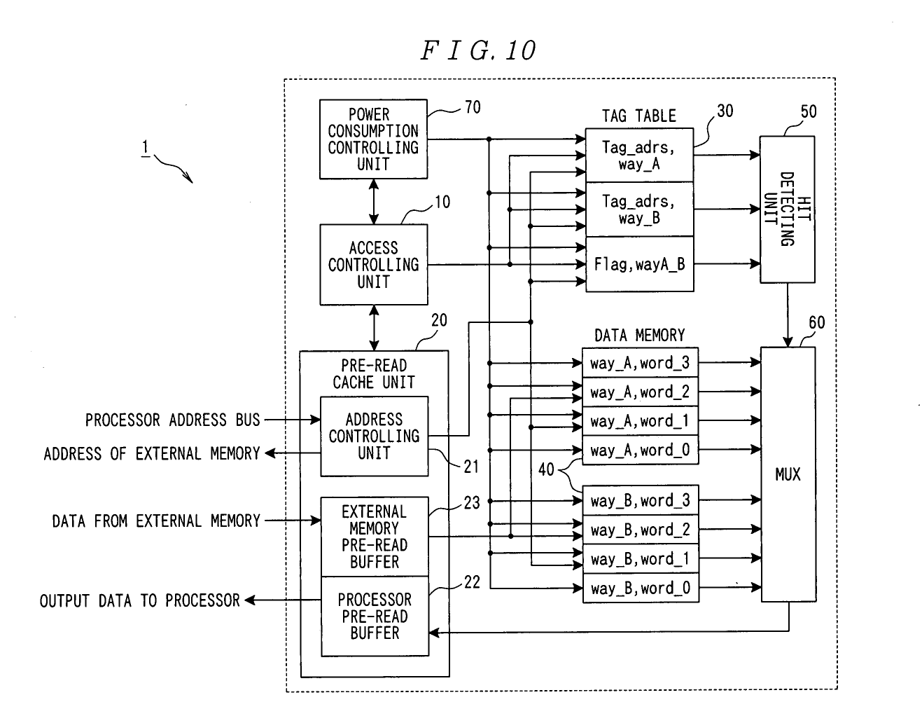

FIG. 10 shows a configuration where the cache memory controlling apparatus 1 is provided with the clock gating function.

In FIG. 10, the cache memory controlling apparatus 1 comprises a power consumption controlling unit 70 in addition to the configuration shown in FIG. 1.

The power consumption controlling unit 70 is provided with a function to stop the supply of clock signals to parts not operating in the cache memory controlling apparatus 1.

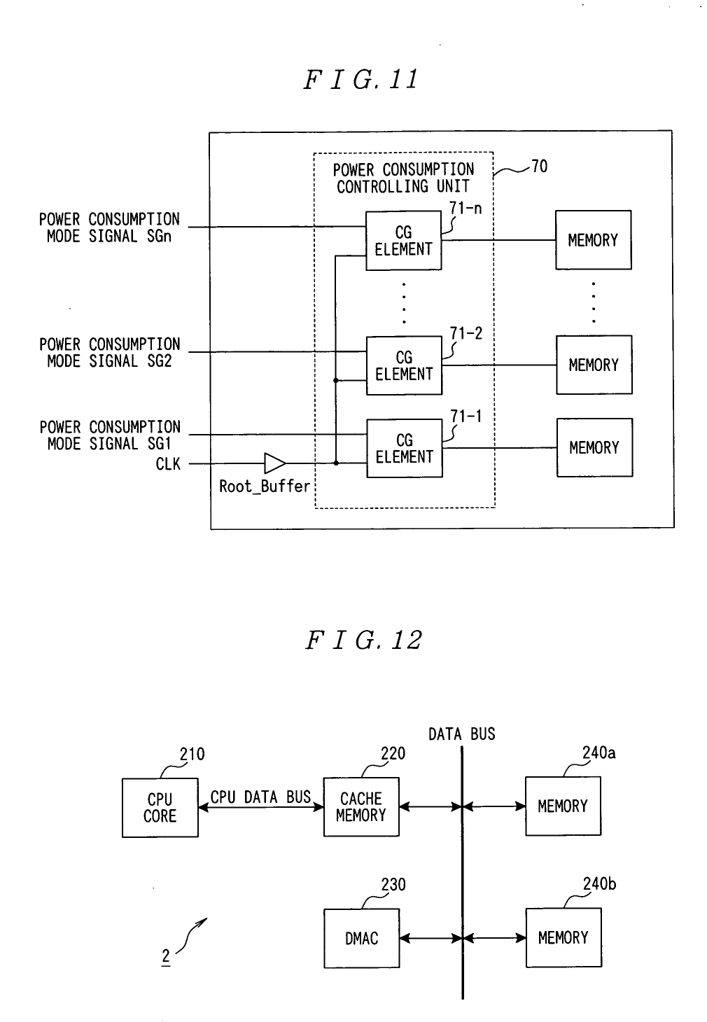

FIG. 11 shows the configuration of the power consumption controlling unit 70.

In FIG. 11, the power consumption controlling unit 70 comprises clock gating elements (hereinafter referred to as “CG elements”) 71-1 to 71-n corresponding to n memories, respectively.

Power consumption mode signals SG1 to SGn for switching on whether the clock signal is supplied or not are inputted from the access managing unit 10 to these CG elements 71-1 to 71-n, respectively. The access managing unit 10 outputs a power consumption mode signal for stopping the supply of the clock signal to a memory of which the operation is determined to be unnecessary, and outputs a power consumption mode signal for supplying the clock signal to a memory of which the operation is determined to be carried out.

With this configuration, the clock signal can be supplied to only a way of the data memory 40 in which data to be read in the pre-read cache unit 20 is stored, thus making it possible to further reduce power consumption.

(Second Embodiment)

The second embodiment of the present invention will now be described.

In this embodiment, coherency between a cache memory and a memory device can be ensured without executing cache flush by newly providing a write flush mode in addition to a write back mode and a write through mode in a conventional cache memory. Further, in the present invention, the hit rate of a cache and the processing speed can be improved by providing a lock mode.

First, the configuration will be described.

FIG. 12 is a schematic diagram showing the configuration of an information processing apparatus 2 applying the present invention.

In FIG. 12, the information processing apparatus 2 comprises a CPU (Central Processing Unit) core 210, a cache memory 220, a DMAC 230 and memories 240a and 240b, and these parts are connected through a bus.

The CPU core 210 controls the entire information processing apparatus 2, and executes predetermined programs to carry out various kinds of processing. For example, the CPU core 210 executes an inputted program while repeating an operation of reading data or an instruction code to be calculated from predetermined addresses of the memories 240a and 240b to carry out calculation processing and writing the calculation results in the predetermined addresses of the memories 240a and 240b. At this time, for enhancing the speed of processing of making accesses to the memories 240a and 240b by the CPU core 210, data is inputted and outputted through the cache memory 220.

The CPU core 210 selects any one of the write through mode, the write back mode and write flush mode as an instruction to write data, and outputs the same to the cache memory 220.

In the write through mode, if data to be written hits the cache, data is written in the cache memory 220, and also written in the memories 240a and 240b, and the cache in which the data is written is brought into a valid state. Furthermore, if data to be written mishits the cache, data is written only in the memories 240a and 240b, and is not written in the cache memory 220.

In the write back mode, if data to be written hits the cache, data is written in the cache memory 220, the cache in which the data is written is brought into a valid state, and no data is written in the memories 240a and 240b. At this time, write is controlled according to the state of a Dirty flag indicating whether data in the cache memory 220 matches corresponding data in the memories 240a and 240b or not (i.e. only data in the cache memory 220 is rewritten or not). Furthermore, if data to be written mishits the cache, an area to be updated in the cache memory 220 is determined in accordance with the LRU algorithm, and data stored in the area is written onto the memories 240a and 240b if required (i.e. if the Dirty flag is “1” as described later) according to the state of the Dirty flag. Data is filled (read) in the area of the cache memory 220 allocated by writing data stored in the cache memory 220 on the memories 240a and 240b from addresses of the memories 240a and 240b referring to the address of data to be written, and the filled data in the cache memory 220 is updated to data to be written.

In the write flush mode, if data to be written hits the cache, data is not written in the cache memory 220 but is written only in the memories 240a and 240b, and the cache in which the data is written is brought into an invalid state. Furthermore, if data to be written mishits the cache, data is written only in the memories 240a and 240b, and no data is written in the cache memory 220.

Furthermore, the CPU core 210 can select a lock mode as a mode for holding data in the cache memory 220 aside from the three modes described above.

By making an access to data in the lock mode, data temporarily captured in the cache memory 220 is continuously held without being updated with the LRU algorithm.

The cache memory 220 comprises memory elements capable of being accessed from the CPU core 210 more speedily than the memories 240a and 240b, and the speed of processing for inputting and outputting data with the memories 240a and 240b by the CPU core 210.

There are various kinds of modes for the cache memory but here, explanation is given using a cache memory of the set associative mode of 2 ways (ways A and B) as an example because the set associative mode is common.

The set associative mode is a mode such that the cache memory is divided into a plurality of areas (ways), and data of a different address on the memory device is stored in each way, whereby the hit rate is improved.

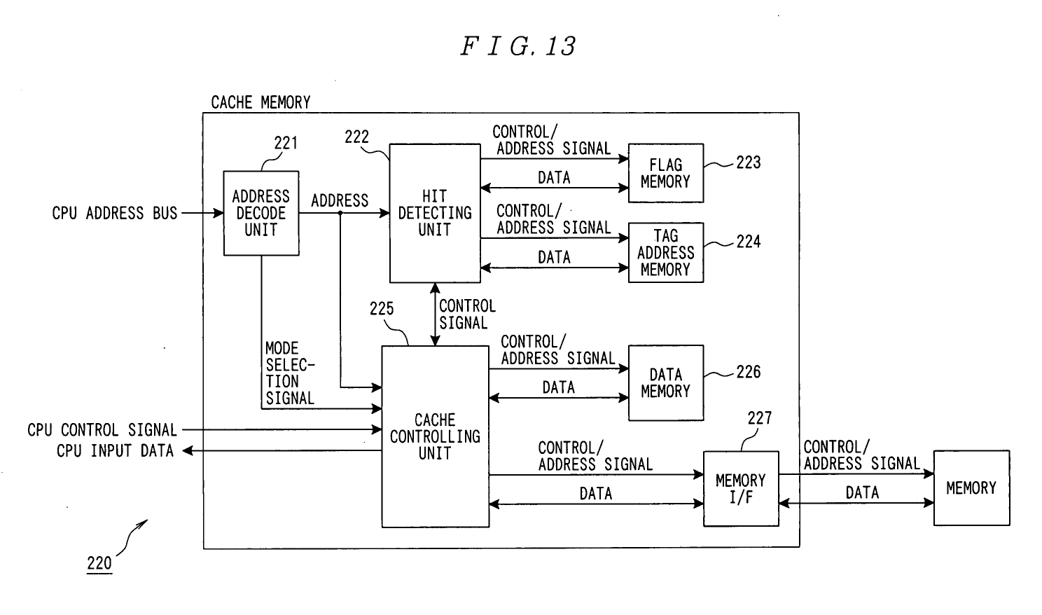

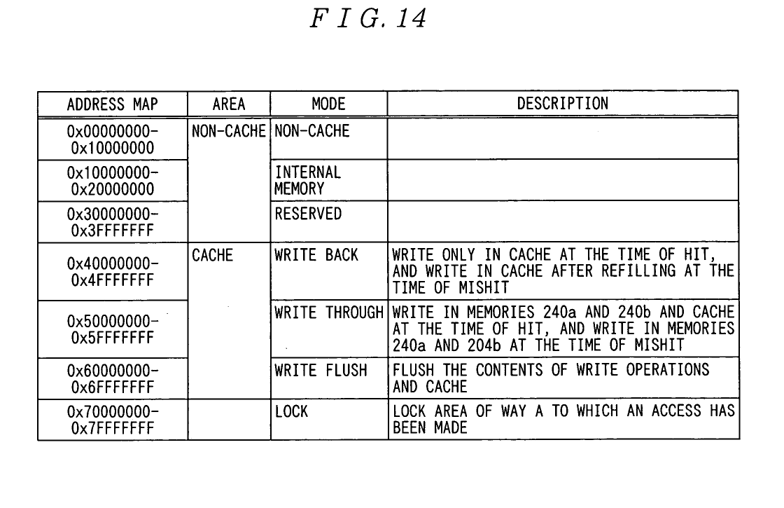

FIG. 13 is a block diagram showing the functional configuration of the cache memory 220.

In FIG. 13, the cache memory 220 comprises an address decode unit 221, a hit detecting unit 222 and a flag memory 223, a tag address memory 224, a cache controlling unit 225, a data memory 226 and a memory interface (I/F) 227.

The address decode unit 221 decodes an address inputted through a CPU address bus from the CPU core 210, and outputs to the cache controlling unit 225 a signal indicating a mode for write in the cache memory 220 (write through mode, write back mode, write flush mode or lock mode) (hereinafter, signal indicating a mode of an instruction is referred to as “mode selection signal”), and calculates addresses to be accessed on the memories 240a and 240b and outputs the same to the hit detecting unit 222 and the cache controlling unit 225.

The hit detecting unit 222 detects whether data stored in the data memory 226 hits the cache or not when an address is inputted from the address decode unit 221. Specifically, a reference is made to each of addresses stored in the tag address memory 224, and when an address inputted from the address decode unit 221 is detected, whether or not a flag (Valid flag described later) stored in the flag memory 223 indicates that the address is valid is determined, and if it indicates that the address is valid, a control signal indicating that the cache is hit (hereinafter referred to as “cache hit signal) is outputted to the cache controlling unit 225. This cache hit signal includes information indicating the address, way and entry of data hitting the cache in the cache memory 220. If the cache is not hit, the hit detecting unit 222 outputs to the cache controlling unit 225 a control signal indicating that the cache is not hit (hereinafter referred to as “cache mishit signal”.

The flag memory 223 stores a Valid flag indicating effectiveness of data of each way, a Used flag indicating a way to be used next, a Lock flag indicating a limitation on update of the entry, and a Dirty flag indicating whether or not data in the cache memory 220 matches corresponding data in the memories 240a and 240b (i.e. whether or not only data in the cache memory 220 is rewritten), for each of data stored in entries of the data memory 226. These flags are sequentially rewritten to values indicating latest states in response to access to the cache memory 220 by the CPU core 210.

The tag address memory 224 stores addresses on the memories 240a and 240b in which data of ways are stored for each of data stored in entries of the data memory 226. These addresses are sequentially rewritten as the entry in the cache memory 220 is updated.

When a control signal providing instructions to read or write data on the memories 240a and 240b (hereinafter referred to as “CPU control signal) is inputted from the CPU core 210, the cache controlling unit 225 carries out predetermined processing according to whether the data hits the cache or not. That is, if data to be read hits the cache (the cache hit signal is inputted from the hit detecting unit 222) when the CPU control signal providing instructions to read data is inputted from the CPU core 210, data to be read is read from the data memory 226, and the data is determined to be data to be outputted to the CPU core 210 (hereinafter referred to as “CPU input data”).

If data to be read does not hit the cache (the cache mishit signal is inputted from the hit detecting unit 222), the cache controlling unit 225 reads data to be read from the memories 240a and 240b based on the address inputted from the address decode unit 221, determines the data to be CPU input data, and stores the data in the cache memory 220.

Furthermore, when the CPU control signal providing instructions to write data is inputted from the CPU core 210, the cache controlling unit 225 determines whether the mode is the write through mode, write back mode or write flush mode based on the mode selection signal inputted from the address decode unit 221 if the data hits the cache (the cache hit signal is inputted from the hit detecting unit 222).

If the mode is the write through mode, the cache controlling unit 225 writes data instructed to be written by the CPU control signal in the memories 240a and 240b based on the address inputted from the address decode unit 221, and updates data in the data memory 226 corresponding to the entry and way inputted from the hit detecting unit 222 to data instructed to be written by the CPU control signal. At this time, the Valid flag for the updated data indicates that the data is valid.

If the mode is the write back mode, the cache controlling unit 225 updates data in the data memory 226 corresponding to the entry and way inputted from the bit detecting unit 222 to data instructed to be written by the CPU control signal without making accesses to the memories 240a and 240b. At this time, the Valid flag for the updated data indicates that the data is valid. Furthermore, the Dirty flag indicating that the data memory 226 of the cache memory 220 matches the memories 240a and 240b is updated at the same time.

If the mode is the write flush mode, the cache controlling unit 225 writes data instructed to be written by the CPU control signal in the memories 240a and 240b based on the address inputted from the address decode unit 221, and does not update data in the data memory 226. At this time, the Valid flag for data in the data memory 226 corresponding to the entry and way inputted from the hit detecting unit 222 indicates that the data is invalid.

When the CPU control signal providing instructions to write data is inputted from the CPU core 210, the cache controlling unit 225 writes data in the cache memory 220 only if the mode selection signal inputted from the address decode unit 221 indicates the write back mode, and writes data only in the memories 240a and 240b if the mode selection signal indicates other mode, if the data does not hit the cache (the cache mishit signal is inputted from the hit detecting unit 222).

Specifically, if the mode is write back mode, the cache controlling unit 225 writes data instructed to be written by the CPU control signal in an area in which data to be deleted in accordance with the LRU algorithm or a vacant area in the data memory 226 according to the state of the Dirty flag, and does not write data in the memories 240a and 240b.

Furthermore, in FIG. 13, the data memory 226 stores predetermined data on the memories 240a and 240b, such as data that is accessed with high frequency. Further, in the data memory 226, data corresponding to ways A and B, respectively, can be stored.

The memory I/F 227 is an input/output interface for the cache controlling unit 225 to make accesses to the memories 240a and 240b.

Referring to FIG. 12 again, the DMAC 230 controls the DMA in the memories 240a and 240b, brings the CPU core 210 into a wait state during execution of the DMA, and notifies the CPU core 210 of completion of the DMA.

The memories 240a and 240b are each constituted by a volatile memory such as a SDRAM (Synchronous Dynamic Random Access Memory), for example, and store instructions to be read when the CPU core 210 executes a program, or data to be calculated.

Furthermore, addresses indicating physical memory spaces and addresses indicating modes of instructions for write or read are assigned in memory spaces constituted by the memories 240a and 240b.

FIG. 14 shows an address map of memory spaces constituted by the memories 240a and 240b.

In FIG. 14, the top level of the address indicates the mode of instructions for write or read, and the lower address following the top level indicates the physical memory space of the memories 240a and 240b.

For example, the address beginning with “0x4” (“4” of hexadecimal number) indicates the write back mode, and the address beginning with “0x5” (“5” of hexadecimal number) indicates the write through mode. Furthermore, the address beginning with “0x6” (“6” of hexadecimal number) indicates the write flush mode, and the address beginning with “0x7” indicates the lock mode.

According to this address map, the CPU core 210 designates the top-level address corresponding to the mode of instructions, and the physical address of the memories 240a and 240b in which data to be calculated is stored.

Operations will now be described.

First, the CPU core 210 provides instructions to read or write data to the cache memory 220 by designating the addresses shown in FIG. 14.

Then, the address decode unit 221 of the cache memory 220 determines the mode based on the top-level address under instructions. According to the determined mode, the hit detecting unit 222 updates each flag and address, and the cache controlling unit 225 updates the data memory 226, writes data in the memories 240a and 240b, and reads data from the memories 240a and 240b and stores the data in the data memory 226.

By carrying out such operations, the flags are sequentially updated according to the mode of instructions.

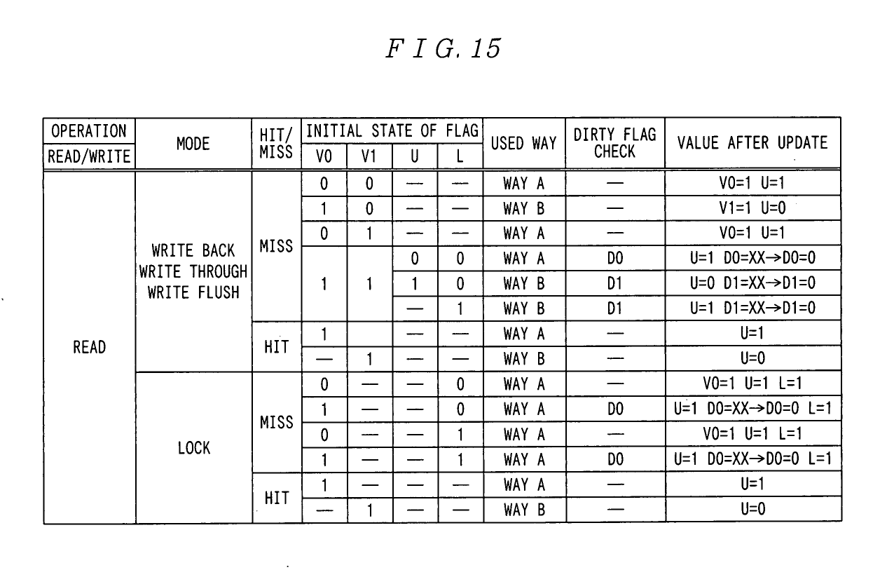

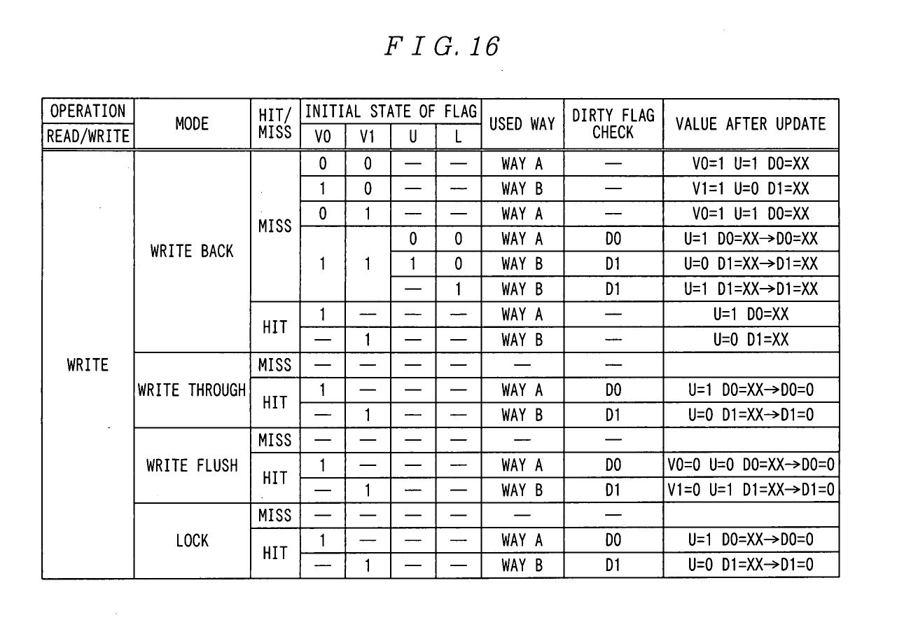

FIG. 15 shows the state transition of each flag where a read instruction is provided, and FIG. 16 shows the state transition of each flag where a write instruction is provided. In FIGS. 15 and 16, the type of instruction (read instruction “Read” or write instruction “Write”), the mode (Mode), whether the cache is hit or not (hit/miss), the initial state of the flag (V0, V1: Valid flag, U: Used flag, and L: Lock flag), the way that is used (Used Way), the Dirty flag to be checked (DirtyFlag check), and the value of the flag after update (post-update value) are shown. In FIGS. 15 and 16, columns “−” having no values refer to “don't care” (ignored), and “X” indicates that the value of “0” or “1” is used.

First, the case of the read instruction will be briefly described with reference to FIG. 15.

In FIG. 15, in the case of the read instruction, the write through mode, the write back mode and the write flush mode are identical in state transition.

For example, when the initial state of each flag is V0=0, V1=0 if read instructions of the write through mode, the write back mode and the write flush mode are inputted and the cache is mishit, the way A is used irrespective of the value of the Used flag, and valid data is written in the way A when the way A is used, and therefore the Valid flag is V0=1, and further the way to be updated next is the way B, and therefore the Used flag is U=1 (see the pattern of the highest level in FIG. 15).

Furthermore, for example, when the initial state of each flag is V0=1, V1=1, and the Used flag is U=0 if read instructions of the write through mode, the write back mode and the write flush mode are inputted, and the cache is mishit, the way A is used, and data is written (filled) in the way A, and therefore the Dirty flag DO is checked before the write. If D0=1 holds, data in the cache memory 220 is rewritten, and its contents are not reflected in the memories 240a and 240b, and therefore the data is written onto the memories 240a and 240b from the cache memory 220, and then new data is read in the cache memory 220. Furthermore, if D0=0 holds, it is not necessary to write data, and therefore new data is just read in the cache memory 220. Furthermore, the way to be updated next is the way B, and therefore the Used flag is U=1, and the Dirty flag for newly written data is D0=0 (see the pattern of the fourth level in FIG. 15).

Furthermore, for example, when the initial state of the Validflag V0 is V0=1, and the way A is hit if read instructions of the write through mode, the write back mode and the write flush mode are inputted, and the cache is hit, a value is read from the way A, and the way to be updated next is the way B, and therefore the Used flag is U=1 (see the pattern of the seventh level in FIG. 15). The state update algorithm of the cache here follows the LRU.

In the lock mode, for example, if the read instruction of the lock mode is inputted, and the cache is mishit, the way A is used irrespective of the state of each flag (V0, V1, U and L), valid data is written in the way A, and the data is held (locked). For the state of the flag, the Valid flag is V0=1 and the Lock flag is L=1, and the way to be updated next is the way B, and therefore the Used flag is U=1 (see patterns of ninth to twelfth levels in FIG. 15).

In this way, in the present invention, data can be held in a specific way if the lock mode is selected. Furthermore, the lock mode in the present invention can be selected only for the way A. That is, in the present invention, the lock mode is a mode provided only for the way A.

Furthermore, for example, when the initial state of each flag is V0=1, L=0, and the way A is already used if the read instruction of the lock mode is inputted, and the cache is mishit, data is written (filled) in the way A, and therefore the Dirty flag D0 is checked before the write. If D0=1 holds, data in the cache memory 220 is rewritten, and its contents are not reflected in the memories 240a and 240b, and therefore the data is written onto the memories 240a and 240b from the cache memory 220, and then new data is read in the cache memory 220. Furthermore, if D0=0 holds, it is not necessary to write data, and therefore new data is just read in the cache memory 220. Furthermore, the way to be updated next is the way B, and therefore the Used flag is U=1, and the Dirty flag for newly written data is D0=0. Further, the newly written data is held, and therefore the Lock flag is L=1 (see the pattern of the tenth level in FIG. 15).

In other cases, the flag is similarly updated according to the mode of instructions.

The case of the write instruction will now be briefly described with reference to FIG. 16.

In FIG. 16, in the case of write instruction, the write through mode, the write back mode, the write flush mode and the lock mode are different in state transition.

For example, when the initial state of each flag is V0=0, V1=0 if the write instruction of the write back mode is inputted and the cache is mishit, the way A is used irrespective of the value of the Used flag, and valid data is written in the way A, and therefore the Valid flag is V0=1, and further the way to be updated next is the way B, and therefore the Used flag is U=1. Furthermore, data is written in the cache memory 220, but the data is not written in the memories 240a and 240b, and therefore the Dirty flag is D0=1 (see the pattern of the highest level in FIG. 16).

Furthermore, for example, when the initial state of each flag is V0=1, V1=1, and the Used flag is U=0 if the write instruction of the write back mode is inputted, and the cache is mishit, the way A is used, and data is written (filled) in the way A, and therefore the Dirty flag D0 is checked before the write. If D0=1 holds, data in the cache memory 220 is rewritten, and its contents are not reflected in the memories 240a and 240b, and therefore the data is written onto the memories 240a and 240b from the cache memory 220, and then new data is read in the cache memory 220. If D0=0 holds, it is not necessary to write data, and therefore new data is just read in the cache memory 220. Furthermore, the way to be updated next is the way B, and therefore the Used flag is U=1, and the Dirty flag for newly written data is D0=1 (see the pattern of the fourth level in FIG. 16).

Furthermore, for example, when the state of the Valid flag V0 is V0=1, and the way A is hit if the write instruction of the write through mode is inputted, and the cache is hit, data is written (filled) in the way A, and therefore the Dirty flag D0 is checked before the write. If D0=1 holds, data in the cache memory 220 is rewritten, and its contents are not reflected in the memories 240a and 240b, and therefore the data is written onto the memories 240a and 240b from the cache memory 220, and then new data is read in the cache memory 220. If D0=0 holds, it is not necessary to write data, and therefore new data is just read in the cache memory 220. Furthermore, the way to be updated next is the way B, and therefore the Used flag is U=1, and the Dirty flag for newly written data is D0=0 (see the pattern of the tenth level in FIG. 16).

Furthermore, for example, when the state of the Valid flag V0 is V0=1, and the way A is hit if the write instruction of the write flush mode is inputted, and the cache is hit, data is written (filled) in the way A, and therefore the Dirty flag D0 is checked before the write. If D0=1 holds, data in the cache memory 220 is rewritten, and its contents are not reflected in the memories 240a and 240b, and therefore the data is written onto the memories 240a and 240b from the cache memory 220, and then new data can be read in the cache memory 220. If D0=0 holds, it is not necessary to write data, and therefore new data can be just read in the cache memory 220. Furthermore, in the case of the write flush mode, the used way A is released. That is, the Valid flag V0 is V0=0 (invalid), and the way to be updated next is the hit way (way A in this example), and therefore the Used flag is U=0, the Dirty flag for newly read data is reset (see the pattern of the thirteenth level in FIG. 16).

The ways of the cache memory 220 according to this embodiment have a plurality of word lengths, and one Dirty flag is set for a plurality of words. For a plurality of words for which the same Dirty flag is set, the words are inputted to or out putted from the cache memory 220 not on a word-by-word basis but collectively. Accordingly, if the write instruction for a specific word is executed, coherency with the memories 240a and 240b should be ensured for other words for which the same Dirty flag is set. Thus, in the case of the write through mode and write flush mode, the Dirty flag is checked and data is written onto the memories 240a and 240b as described above. Furthermore, in the case of the write through mode and write flush mode, the cache memory 220 is not manipulated if the cache is mishit.

Further, for example, when the state of the Valid flag V0 is V0=1, and the way A is hit if the write instruction of the lock mode is inputted, and the cache is hit, data is written (filled) in the way A, and therefore the Dirty flag DO is checked before the write. If D0=1 holds, data in the cache memory 220 is rewritten, and its contents are not reflected in the memories 240a and 240b, and therefore the data is written onto the memories 240a and 240b from the cache memory 220, and then new data is read in the cache memory 220. If D0=holds, it is not necessary to write data, and therefore new data is just read in the cache memory 220. Furthermore, in the case of the lock mode, data of the way A is held. Thus, the way to be updated next is always the way B, and therefore the Used flag is U=1, and the Dirty flag for newly written data is D0=0 (see the pattern of the sixteenth level in FIG. 16).

In this way, in each instruction, the switching between modes can be done by designating a mode by the CPU core 210, whereby data can be flexibly written onto the memories 240a and 240b from the cache memory 220.

A specific processing flow where the switching is done between modes during execution of a program will be described below.

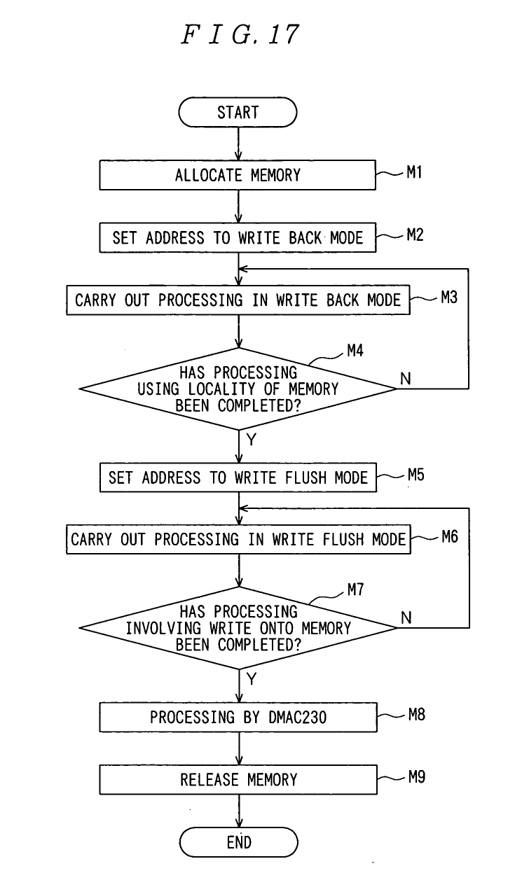

FIG. 17 is a flow chart showing processing where the switching is done between the write back mode and the write flush mode during execution of a program.

In FIG. 17, when processing is started, the CPU core 210 allocates memory areas that are used in the memories 240a and 240b (step M1), and sets a designated address in read or write instructions to the address corresponding to the write back mode (sets the top level of the address to “0x4”) (step M2).

The CPU 210 carries out processing in the write back mode (step M3), and determines whether all of processing in the write back mode, i.e. processing using locality of data has been completed or not (step M4).

If it is determined at step M4 that all of processing using locality of data has not been completed, the CPU core 210 moves to processing of step M3, and if it is determined that all of processing using locality of data has been completed, the CPU core 210 sets a designated address in read or write instructions to the address corresponding to the write flush mode (sets the top level of the address to “0x6”) (step M5).

Then, the CPU core 210 carries out processing in the write flush mode (step M6), and determines whether all of processing in the write flush mode, i.e. processing involving write onto the memories 240a and 240b has been completed or not (step M7).

If it is determined at step M7 that all of processing involving write onto the memories 240a and 240b has not been completed, the CPU core 210 moves to processing of step M6, and if it is determined that all of processing involving write onto the memories 240a and 240b has been completed, the CPU core 210 carries out processing by the DMAC 230 (DMA transfer, etc.) (step M8).

The CPU core 210 releases the memory areas allocated at step M1 (step M9) to complete processing.

In this way, if high coherency between data stored in the cache memory 220 and data stored in the memories 240a and 240b is required as in the DMA, the switching can be done from the write back mode (or other mode) to the write flush mode during execution of a program, whereby the necessity to perform cache flush is eliminated, thus making it possible to enhance the processing speed of the information processing apparatus 2, and entries of the cache memory 220 are sequentially released, thus making it possible to use the cache memory 220 efficiently.

Processing where the switching is done between the write back mode and the lock mode during execution of a program will now be described.

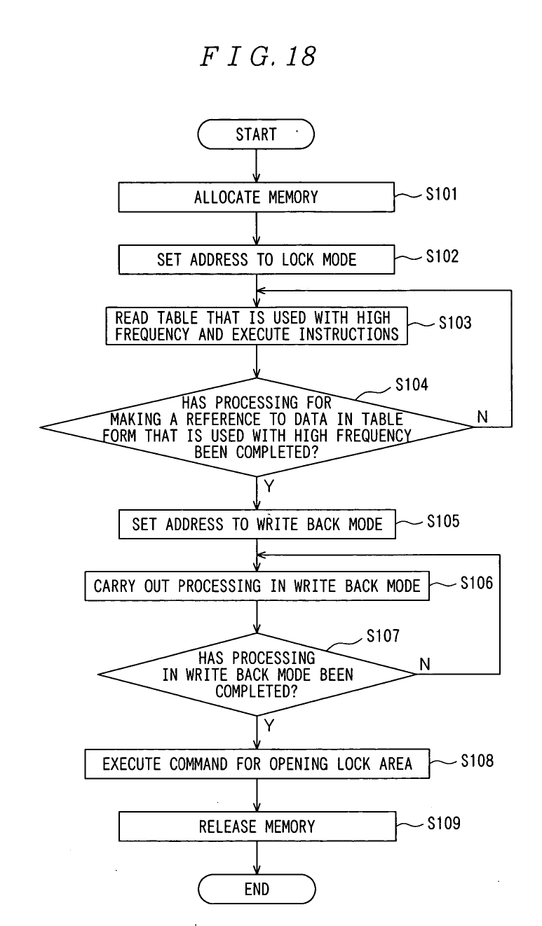

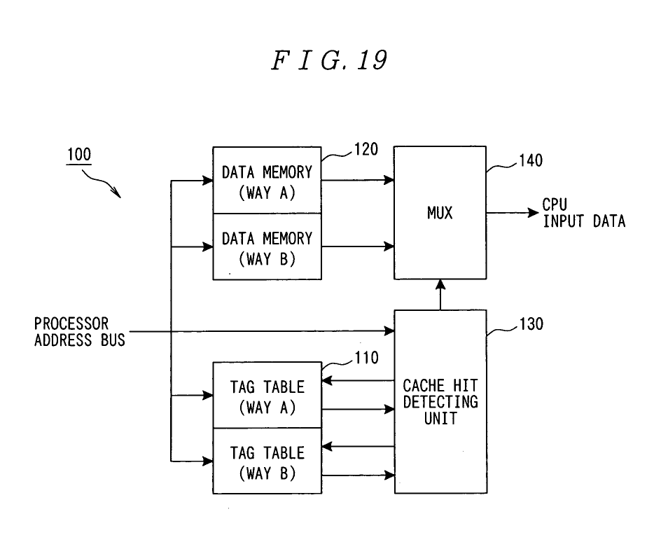

FIG. 18 is a flow chart showing processing where the switching is done between the write back mode and the lock mode during execution of a program.

In FIG. 18, when processing is started, the CPU core 210 allocates memory areas that are used in the memories 240a and 240b (step S101), and sets a designated address in read or write instructions to the address corresponding to the lock mode (sets the top level address to “0x7”) (step S102).

The CPU core 210 reads data in table form that is used with high frequency onto the cache memory 220 from the memories 240a and 240b, and carries out processing involving reference to the data (step S103).

Here, the data read at step S103 is not limited to data in table form as long as it is data that is used with high frequency and kept at fixed values.

Then, the CPU core 210 determined whether all of processing for making a reference to data in table form that is used with high frequency has been completed or not (step S104).

If it is determined at step S104 that all of processing for making a reference to data in table form that is used with high frequency has not been completed, the CPU core 210 moves to processing of step S103, and if it is determined that all of processing for making a reference to data in table form that is used with high frequency has been completed, the CPU core 210 sets a designated address in read or write instructions to the address corresponding to the write back mode (sets the top level of the address to “0x4”) (step S105).

Then, the CPU core 210 carries out processing in the write back mode (step S106), and determines whether all of processing in the write back mode has been completed or not (step S107).

If it is determined at step S107 that all of processing in the write back mode has not been completed, the CPU core 210 moves to processing of step S106, and if all of processing in the write back mode has been completed, the CPU core 210 executes a command for releasing the area in which data held in the lock mode is stored (lock area) (step S108).

The CPU core 210 releases the memory areas allocated at step S101 (step S109) to complete processing.

In this way, if a reference is made to data that is used with high frequency and kept at fixed values such as data in table form, the switching to the write back mode (or other mode) can be done after completion of processing for reading or writing data in the lock mode, and making a reference to data that is used with high frequency and kept at fixed values, whereby the hit rate of the cache can be improved, thus making it possible to enhance the processing speed of the information processing apparatus 2.

As described above, the information processing apparatus 2 according to this embodiment can execute read or write instructions in the write flush mode in addition to the conventional write back mode and write through mode.

Thus, high coherency between data in the cache memory 220 and data in the memories 240a and 240b can be ensured without performing cache flush, thus making it possible to enhance the processing speed of the information processing apparatus 2.

Furthermore, if the instruction to write data is executed in the write flush mode, the entry of the cache memory 220 in which the written data is stored is released, thus making it possible to use the cache memory 220 efficiently.

Furthermore, the information processing apparatus 2 according to this embodiment can execute read or write instructions in the lock mode.

Thus, data that is used with high frequency and kept at fixed values can be held in the cache memory 220 as required, thus making it possible to improve the hit rate of the cache and enhance the processing speed.

Furthermore, the information processing apparatus 2 according to this embodiment can do the switching among the write back mode, the lock mode and the write flush mode during execution of a program.

For example, when coherency between data in the cache memory 220 and data in the memories 240a and 240b is ensured by writing data in the cache memory 220 onto the memories 240a and 240b, the mode is set to the write through mode and the cache is kept in a valid state for data that is subsequently used, while the mode is set to the write flush mode and the entry is released for data that is no longer used thereafter, whereby the sate of the cache memory 220 can be controlled.

Thus, the mode of instructions can be flexibly changed according to the contents of processing of a program, and processing efficiency can be thus improved.

1. A cache memory controlling apparatus capable of caching at least part of stored data in a cache memory including a plurality of ways from a memory device storing data to be read by a processor, and supplying the cached data to the processor, the cache memory control apparatus comprising:
a cache determining section determining whether or not predetermined data expected to be read subsequently to data being read by the processor is cached in any of the ways of said cache memory; and
a pre-read cache section making an access to a way in which the predetermined data is stored, of said plurality of ways, and reading and storing the predetermined data, if it is determined by said cache determining section that said predetermined data is cached in any of the ways,
wherein said pre-read cache section outputs the stored predetermined data to the processor if said predetermined data is read subsequently to said data being read.

2. The cache memory controlling apparatus according to claim 1, wherein said cache memory comprises an address storing section storing addresses of data cached for said plurality of ways, and a data storing section storing data corresponding to the addresses,
said cache determining section determines whether the predetermined data is cached or not according to whether or not the address of said predetermined data is stored in any of the ways of said address storing section, and
said pre-read cache section makes an access to a way corresponding to the way of said address storing section storing the address of said predetermined data, of the plurality of ways of said data storing section.

3. The cache memory controlling apparatus according to claim 1, wherein said predetermined data is data expected to be read just after said data being read.

4. The cache memory controlling apparatus according to claim 1, wherein the data to be read by the processor is constituted as a block including a plurality of words, and, with the block as a unit, whether said predetermined data is cached or not is determined, or said predetermined data is read.

5. The cache memory controlling apparatus according to claim 4, wherein said cache determining section determines whether said predetermined data is cached or not in response to an instruction by the processor to read the last word, of a plurality of words constituting said data being read.

6. The cache memory controlling apparatus according to claim 4, wherein said cache determining section determines whether said predetermined data is cached or not in response to an instruction by the processor to read a word preceding the last word, of a plurality of words constituting said data being read.

7. The cache memory controlling apparatus according to claim 6, wherein said pre-read cache section makes an access to a way in which the predetermined data is stored, and reads the predetermined data in response to an instruction by the processor to read the last word of a plurality of words constituting said data being read if it is determined by said cache determining section that said predetermined data is cached in any of the ways.

8. The cache memory controlling apparatus according to claim 1, further comprising a power consumption reducing section operating ways not involved in read of data at low power consumption, of said plurality of ways in the cache memory.

9. The cache memory controlling apparatus according to claim 8, wherein said power consumption reducing section comprises a clock gating function performing control to supply no clock signal to ways not involved in read of data.

10. The cache memory controlling apparatus according to claim 1, wherein said cache memory is a cache memory of a set associative mode.

11. The cache memory controlling apparatus according to claim 1, wherein said pre-read cache section makes an access to said memory device, and reads and stores the predetermined data if it is determined by said cache determining section that said predetermined data is not cached in any of the ways of said cache memory.

12. A method for control of a cache memory for caching at least part of stored data in a cache memory including a plurality of ways from a memory device storing data to be read by a processor, and supplying the cached data to the processor, the method comprising:
a cache determining step of determining whether or not predetermined data expected to be read subsequently to data being read by the processor is cached in any of the ways of said cache memory;
a pre-read cache step of making an access to a way in which the predetermined data is stored, of said plurality of ways, and reading and storing the predetermined data, if it is determined in said cache determining step that said predetermined data is cached in any of the ways; and
an output step of outputting to the processor the predetermined data stored in said pre-read cache step if said predetermined data is read subsequently to said data being read, by the processor.

13. An information processing apparatus comprising a cache memory capable of caching at least part of stored data from a memory device storing data to be read, and capable of being accessed in a plurality of access modes including at least any one of a write back mode and a write through mode,
wherein an access can be made to said cache memory with the switching done between said plurality of access modes during execution of a program.

14. The information processing apparatus according to claim 13, wherein an access can be made to said cache memory with the switching done between said write back mode and write through mode during execution of a program.

15. The information processing apparatus according to claim 13, wherein said access modes includes a write flush mode in which when data is written, data is not written in an area where the data is stored so that the area is released in said cache memory, and the data is written in a predetermined address in said memory device.

16. The information processing apparatus according to claim 15, wherein in said write flush mode, when data is written, the data is written in a predetermined address in said memory device without making an access to said cache memory if the data is not stored, in said cache memory.

17. The information processing apparatus according to claim 15, wherein an access can be made to said cache memory with the switching done between said write back mode and write flush mode during execution of a program.

18. The information processing apparatus according to claim 15, wherein after coherency between data stored in said cache memory and data stored in said memory device is ensured, the switching can be done to said write through mode or write flush mode.

19. The information processing apparatus according to claim 13, wherein said access modes include a lock mode in which when data is read or written, the data stored in said cache memory is held in distinction from other data.

20. The information processing apparatus according to claim 19, wherein said cache memory is a cache memory of the set associative mode including a plurality of ways, and said lock mode can be set focusing on a specific way in the plurality of ways.

21. The information processing apparatus according to claim 19, wherein an access can be made to said cache memory with the switching done between said write back mode and lock mode during execution of a program.

22. The information processing apparatus according to claim 13, wherein said plurality of access modes are associated with some addresses in a memory space for which a read or write instruction is provided, and said access mode in each instruction can be set by designating an address corresponding to said access mode.

23. A method for control of a cache memory in an information processing apparatus comprising a cache memory capable of caching at least part of stored data from a memory device storing data to be read, and capable of being accessed in a plurality of access modes including at least any one of a write back mode and a write through mode,
wherein an access is made to said cache memory with the switching done between said plurality of access modes during execution of a program.
